(19) United States
(12) Patent Application Publication
(10) Pub. No.: US 2020/0077845 A1
(43) Pub. Date: Mar. 12, 2020

(54) Advanced Basin Liner Apparatus, Method, and System

(71) Applicant: Eramosi Oyathelemi, Gambrills, MD (US)

(72) Inventor: Eramosi Oyathelemi, Gambrills, MD (US)

(21) Appl. No.: 16/563,906

(22) Filed: Sep. 8, 2019

Related U.S. Application Data
(60) Provisional application No. 62/728,785, filed on Sep. 8, 2018.

(51) Int. Cl. A47K 1/06; A47K 3/00; A47J 47/20; B65H 35/10

(52) U.S. Cl. CPC A47K 1/06; B65H 35/10; A47J 47/20; A47K 3/002

(57) ABSTRACT

The disclosure concerns liners that can be adapted to one or more types of wash basins. A novel aspect of this invention is the flexibility of the liners which may be adapted and easily cut to adjust to the shape and size of a variety of different designs. In some embodiments the liners may be perforated such that items may be cleaned on them and the liners easily drained. In some such embodiments, the liners may incorporate attachment means including but not suction cups, adhesives, or magnets to temporarily affix one or more liners to the surface of the basin or one another. Other embodiments may include grooves to fit around magnets. In certain preferred embodiments, the liner may be a one size fits all liner that may be disposable such that a user can throw it away it with any contents therein, in some embodiments being biodegradable or recyclable.

### CROSS-REFERENCE TO RELATED APPLICATIONS

The present application claims priority to U.S. Provisional Patent Application No. 62/728,785, filed Sep. 8, 2018. The entire disclosure of U.S. Provisional Patent Application No. 62/728,785 is incorporated herein by reference.

### TECHNICAL FIELD

The general field of the disclosure herein relates to one or more liners that can be adapted to one or more types of wash basins, including but not limited to a bathtub, sink or shower. A novel aspect of this invention is the flexibility of the liners which may be adapted and easily cut to adjust to the shape and size of a variety of different basin designs. In some exemplary embodiments the liners may be perforated such that items may be cleaned on them and the liners easily drained. In some such embodiments, the liners may incorporate attachment means including but not suction cups, adhesives, or magnets to temporarily affix one or more liners to the surface of the basin, to one another or any combination therein. Other embodiments may involve a sanitization attachment, including but not limited to a bleach, baking soda, or vinegar allowing users to quickly sanitize the liner. In certain preferred embodiments, the liner may be a one size fits all liner that is fitted by means including, but not limited to folding or stretching the liner around the contours of the basin and in some such embodiments it may be disposable such that a user can wrap it up as they would a trash bag, and throw it away it with any contents therein, in some such embodiments being biodegradable, in others composed of recyclables.

### BACKGROUND

Disposable liners have existed for decades. Patents in the field relate to sink liners mounted to countertops, sheet liners secured about the tank rim secured by hooks and loop fasteners or even more limited rectangular shapes for the medical field (see U.S. Pat. No. 3,931,651 to Weir; U.S. Pat. No. 4,602,393 to Fiveash; U.S. Pat. No. 5,153,950 to Sowers; U.S. Pat. No. 5,465,436 to Bleicher; U.S. Pat. No. 5,815,856 to Dore, and U.S. Pat. No. 6,338,171 to Dandridge). There exists no prior art known to the inventor related to completely adjustable and flexible basin liners. The closest existing patented liner appears to be Dandridge's sink hugger, which gets around the prior art by adapting the side panels and bottom panel to conform to the configuration of the sink so that the liner completely covers the sink, while being mounted to the countertop. The liners disclosed herein do not need to be mounted to the countertop, they can be bonded to the surface of the basin itself via adhesive means, and in some embodiments have a cutting component on or about a dispensing device to grant the user the greatest flexibility in adapting them to fit the contours of an assortment of basins.

Studies show that bacteria can travel up the pipes of hospital sinks at a rate of about 2.5 centimeters per day to contaminate sink drain covers, sink bowls and countertops Moreover, with only one sink's pipe contaminated, running water alone—with no nutrients—was enough for the bacteria to infiltrate three other sinks through the common drainpipe in just one week. (Kotay, Shireen; Chai, Weidong; Guilford, William; Barry, Katie; Mathers, Amy, “Spread from the Sink to the Patient: in situ Study Using Green Fluorescent Protein (GFP) Expressing-Escherichia coli to Model Bacterial Dispersion from Hand Washing Sink Trap Reservoirs”, Applied and Environmental Microbiology, Feb. 24 2017, http://aem.asm.org/content/early/2017/02/13/AEM.03327-16.abstract, Read Aug. 12 2018).

In washbasins a wealth of harmful bacteria can be spread by unclean surfaces and the improper handling food. People with hepatitis A, noroviruses, or the bacteria staphylococcus and streptococcus can be passed on to others by the improper handling food. Raw meats, poultry, and fish carry a large variety of harmful bacteria. One of the most serious is Escherichia coli 0157:H7. This bacterium causes hemolytic uremic syndrome, an often-deadly disease that strikes mostly children. Older adults are also at high risk. Chicken, turkey, and fowl are associated with shigella, salmonella, and campylobacter. These are bacteria that cause diarrhea, cramping, and fever. Most meat can be contaminated with toxoplasmosis (a parasitic disease dangerous to both pregnant women and fetuses). Seafood, particularly oysters, clams, and other shellfish, can be contaminated with the vibrio species of bacteria that causes diarrhea. Unpasteurized cheese and some meat can be contaminated with Listeria monocytogenes, a strain of bacteria that can cause disease in people and miscarriage or damage to the fetus in pregnant women. Listeria is often found in soft cheeses, such as brie, and more often in imported cheeses than in domestic cheeses. Listeria is one of the few bacteria that grow well in the 40° F. (4° C.) temperature of the refrigerator. Contaminated vegetables and fruits can also carry a variety of organisms and parasites, depending on where they were grown and how they were processed. Items in the kitchen become contaminated by contact with contaminated people, foods, pets, or other environmental sources. Thus, it is important to handle food in clean and sterile environments, which typically means drying and disinfecting kitchen surfaces (Adler, Liora C., MD; Walton-Ziegler, Olivia, M S, PA-C, “In the Kitchen: Prevent the Spread of Infection”, University of Rochester Medical Center-Health Encyclopedia, https://www.urmc.rochester.edu/encyclopedia/content.aspx?contenttypeid=l&contentid=1220, Read Aug. 12 2018). Biodegradable liners may be achieved in some embodiments using a technique involving a biodegradable moisture barrier layer sandwiched between the biodegradable resin layers (as disclosed in U.S. patent application Ser. No. 10/503,946 by Isshiki et al.).

In exemplary embodiments of the present disclosure, one or more removable liners can be adapted to fit one or more wash basins or liners to create a sterile environment for handling items, protect surfaces, or create a sheave to drain fluid while collecting solid debris or semi-solid debris for waste. In some exemplary embodiments the liner may be thin like a trash bag. In some other exemplary embodiments, the liner may be composed of recyclable materials. Another purpose of the liner is to prevent sediment, debris or other unwanted particulates from going down the drain and to make easy cleanup of the washbasin, tub or sink, protecting surfaces, pipelines and wastewater treatment plants.

### SUMMARY OF THE INVENTION

The primary disclosure herein is an apparatus, method and system for one or more liners that can be adapted to one or more types of wash basins, including but not limited to a bathtub, sink or shower. A novel aspect of this invention is the flexibility of the liners which may be adapted and easily cut to adjust to the shape and size of a variety of different basin designs. In some exemplary embodiments the liners may be perforated such that items may be cleaned on them and the liners easily drained. In some such embodiments, the liners may incorporate attachment means including but not limited to suction cups, adhesives, or magnets to temporarily affix one or more liners to the surface of the basin, to one another or any combination therein. Other embodiments may involve a sanitization attachment, including but not limited to a bleach, baking soda, or vinegar allowing users to quickly sanitize the liner. In certain preferred embodiments, the liner may be a one size fits all liner that is fitted by means including, but not limited to folding or stretching the liner around the contours of the basin and in some such embodiments it may be disposable such that a user can wrap it up as they would a trash bag, and throw it away it with any contents therein, in some such embodiments being biodegradable.

The primary components of such embodiments of the disclosure are the liner and its attachment mechanism. In some embodiments of the present disclosure the attachment means may be a mechanism bonding the liner to the sink including but not limited to may be suction cups, adhesives or magnets. Some such embodiments may involve one or more liners comprised of material that naturally adheres to a basin for stability, or naturally clings to skin and/or shoe soles to prevent slips and falls. In other embodiments the attachment means may be a mechanism bonding a liner to another liner including but not limited to a zipper, velcro or electromagnet on both liners. In some such embodiments the liners may include one or more perforations. A perforation may be large rounded holes to allow liquid to seep through several layers of liners before draining. In other embodiments the perforations may be smaller holes, acting as a sheave to retain all but the smallest of fluids. In some such the perforations may be manufacturer created, whereas in other there may be an attachment allowing the user to create them

In certain embodiments the liner or combination of liners may be designed such that they can be easily disposed of. In some such embodiments this may involve the liners being coupled with drawstrings to allow one or more of them to be quickly wrapped around one another. In other such embodiments this may involve an attachment bag on the edge of the liner that the liner may easily be rolled into, in order to capture any moisture that would otherwise seep through the liner perforations.

Additional embodiments of the present disclosure may involve attachment mechanisms designed to cut the disposable liners such that they can be arranged around the wash basin. In some such embodiments these may be cutting tools including but not limited to scissors linked to the dispensing box, a saw built into the box or indentations allowing for ease of breaking off sections in a straight line. Other additional embodiments of the present disclosure may include components designed for sanitization purposes, such as pre-sanitized liners with sodium carbonate built into the liner, or boxes attached to the liner holding treatments including but not limited to a bleach, baking soda, or vinegar allowing users to quickly sanitize the liner.

While the preferred embodiments of the disclosure are shown in the accompanying drawings, it to be understood that said embodiments are susceptible to modification and alteration while still maintaining the spirit of my invention.

### BRIEF DESCRIPTION OF THE DRAWINGS

Referring to the drawings, FIG. 1 is an overview drawing of an exemplary embodiment of a basin liner in this case being designed to fit a tub and with several suction cups to attach to the tub surface and one or more perforations so that it can drain fluid while retaining larger solids.

FIG. 2 is an illustration of exemplary embodiments of a basin liner, in this case having perforated sections, filtered perforations, magnetic attachments and drawstrings such that they can allow a variety of fluids to seep through and drain from one liner to the next and/or from one liner to the basin drain, attach to one another and/or to a basin, and/or be ergonomically disposed of along with their contents.

FIG. 3 is an illustration of an exemplary basin liner which in this case has a dispensing box with a serrated edge allowing the user to cut the liner into multiple sheets that they can fit to a basin such as the sink displayed.

FIG. 4 is an illustration of exemplary embodiments of a basin liner, in this case having perforated sections, and filtered perforations, further comprising a perforation maker.

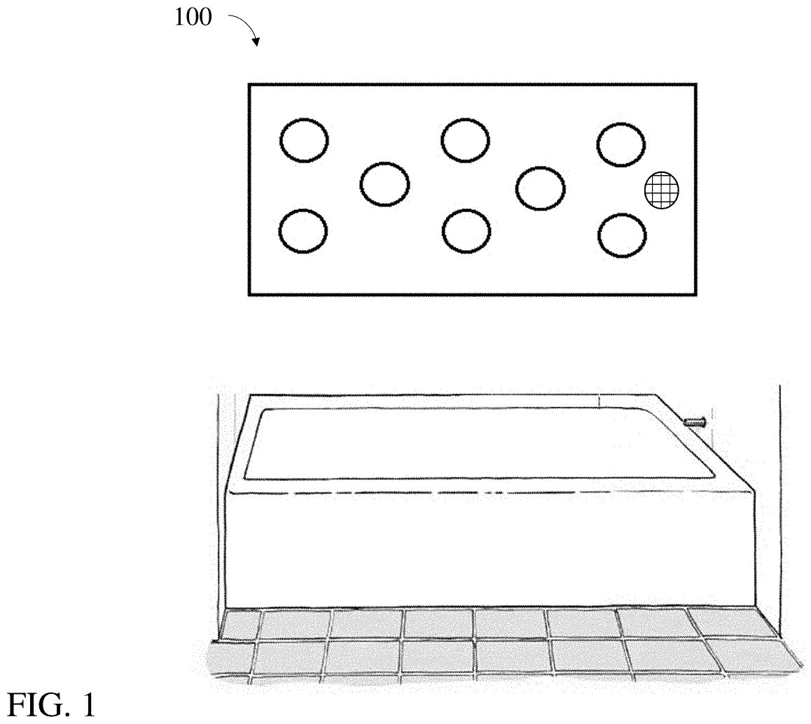

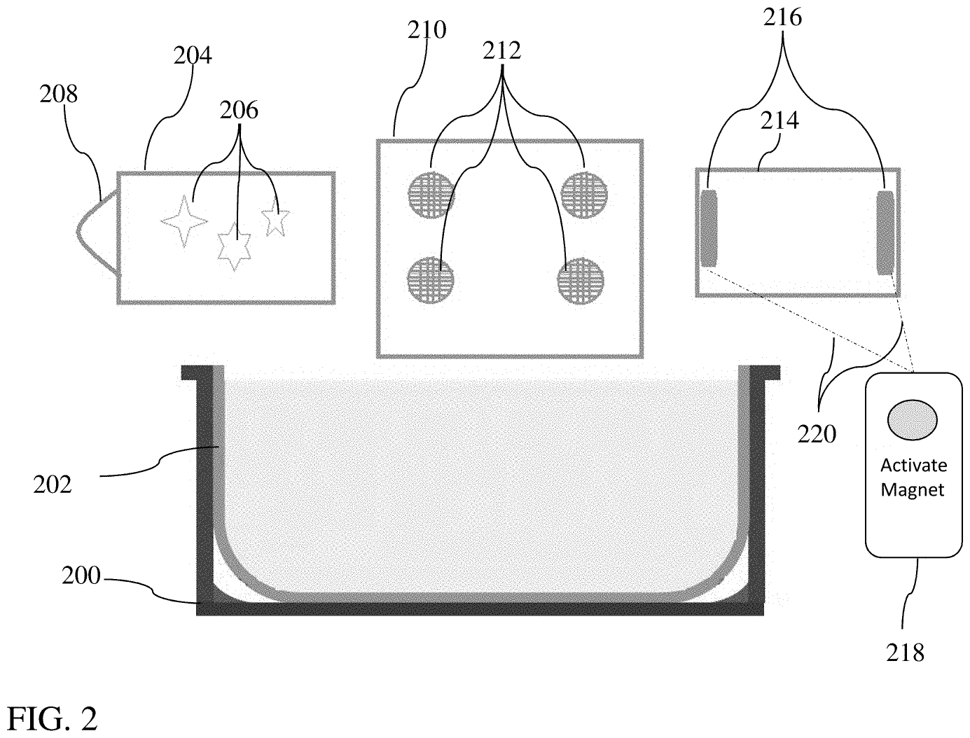

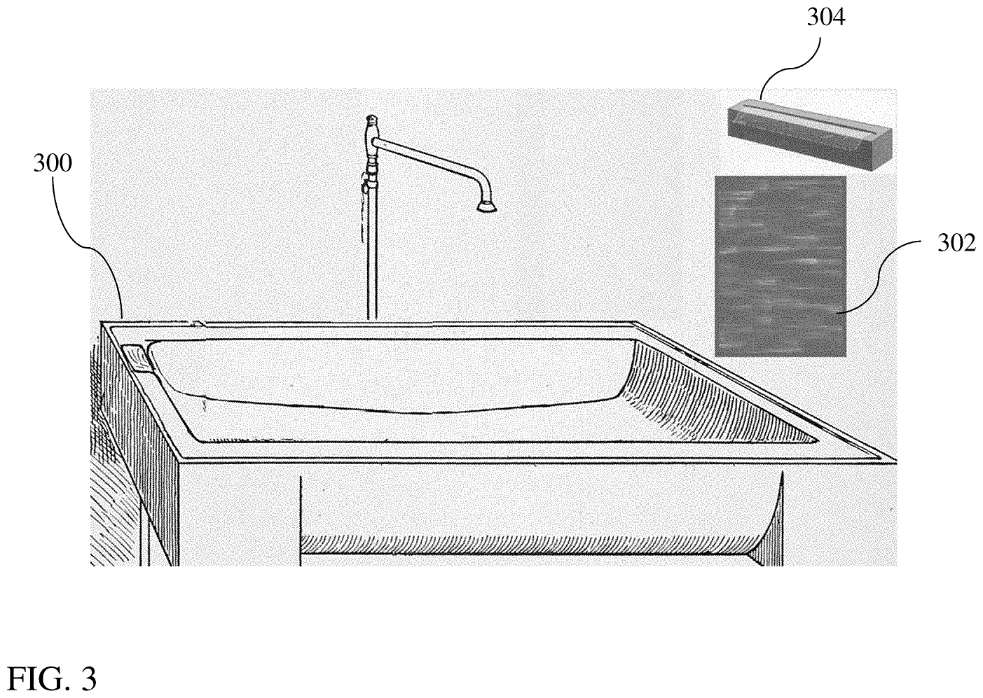

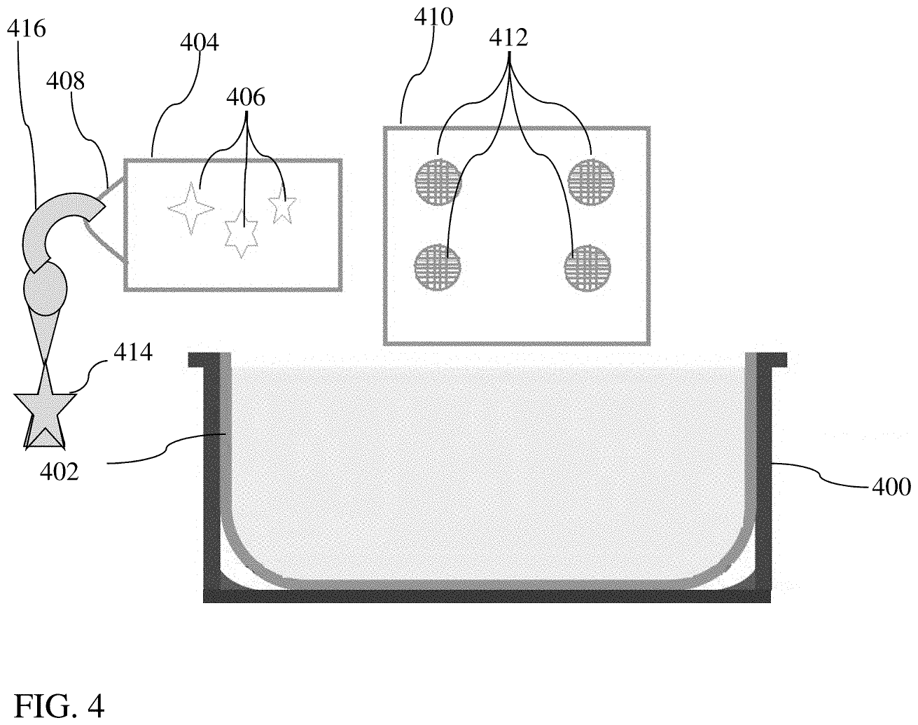

### DETAILED DESCRIPTION

In this disclosure the term ‘basin liner’ refers to any removable liner which has been adapted to be placed over a wash basin, whether by the manufacturer or by the user utilizing manufacturer attachments to the liner including but not limited to the serrated edge of a dispensing box, one or more magnets, or one or more perforations. Additional embodiments may include ergonomic attachments to the liner, including but not limited to drawstrings allowing a user to wrap the liner up after use for ease of dispensing, sanitization packets including baking soda, vinegar or some other cleaning agent, or one or more removable magnets. In this disclosure, the term ‘perforation’ refers to embodiments of the liner that include holes allowing fluid or smaller particulates to drain from one layer of liner to the next or to the basin or basin drain. In some embodiments one or more of the perforations may be designed to fit the contours of the drain by means including but not limited to one or more magnets around the perimeter of the perforation, slack on the perforation such that it extrudes in the vertical direction as opposed to remaining flush with the liner and can extend into a portion of the drain hole, or any combination therein.

One feature shared by all embodiments of the disclosure is the flexibility of the liners which may be adapted and easily cut to adjust to the shape and size of a variety of different basin designs. Some embodiments of the liner may involve a dispensing box for the liner which includes a serrated edge to cut the liner to fit the desired shape. Some other embodiments may involve the liner coming with a cutting attachment including but not limited to a knife, scissors, or a guillotine trimmer. In some exemplary embodiments the liners may be perforated such that items may be cleaned on them using one or more fluids and the liners easily drained. In some such embodiments, the liners may incorporate attachment means including but not limited to suction cups, adhesives, or magnets to temporarily affix one or more liners to the surface of the basin, to one another or any combination therein. Some such embodiments may involve one or more liners comprised of a material that naturally adheres to the surface of the basin utilizing one or more principles including but not limited to electrostatic, hydrophilic or thermal bonding. Some other embodiments may involve one or more liners that with one or more surfaces that adheres to skin and/or shoe soles to prevent slips and falls. Other embodiments may involve a sanitization attachment, including but not limited to a bleach, baking soda, or vinegar allowing users to quickly sanitize the liner. In other such embodiments these attachments may be linked to the liner by means including but not limited to a keychain linking a container for the attachment to one corner of the liner, certain indents in the liner being made to fit a certain depth to collect the sanitization elements one of the liners having a one-time use removable sheet exposing the sanitization layer. In certain preferred embodiments, the liner may be a one size fits all liner that is fitted by means including, but not limited to folding or stretching the liner around the contours of the basin, drain or any combination therein.

Additional exemplary embodiments include disposable liners comprising one or more attachments including retractable drawstrings, mechanisms linking one liner to the next such as zippers or velcro, or an external bag attachment designed so the liners may be rolled into it, such that a user can wrap it up as they would a trash bag, and throw it away it with any contents therein. Some such embodiments of the liner involve it being composed of biodegradable materials such that it may be safely disposed of or degrade when the user finishes washing materials on it. To overcome the moisture proof issues inherent in most biodegradable materials some embodiments of the present disclosure may be designed with multiple layers including but not limited to biodegradable resin layers and a biodegradable moisture barrier layer.

In this disclosure the term ‘electromagnet’ refers to any magnet which may be activated by means including but not limited to an electric charge, release/movement of a magnetic shield, or electromagnetic pulse. In some exemplary embodiments of this disclosure, the liners may be bonded temporarily to one another, to a basin or to any combination therein with the use of one or more electromagnets. Some exemplary embodiments of the present disclosure may include an electromagnet that is activated remotely by means including but not limited to a cell phone application, a remote control, or a wired connection. In some such embodiments the electromagnets could be activated and deactivated with the push of a button to allow for easy and secure attachment and removal of the liner. Some such embodiments may include a means for charging the electromagnet including but not limited to using the wired connection, an external charging pad or replaceable battery that may be inserted into them. In some such embodiments the electromagnets can be separated from the liners such that they may be reused even after the liner is disposed of. In certain embodiments the liners may have perforated slots or indentations which are designed to fit snugly around such removable electromagnets.

As shown in FIG. 1, one or more liners may be utilized to cover basin, in this case a bathtub. Said liner may include multiple perforations such that items including but not limited to food, clothes or children may be cleaned in the tub while any solid material including but not limited to dirt, grime, or blood is collected by the liner which may have rigid edges to collect solid or thicker liquid deposits, while the cleaning moisture drains through the perforations protecting the drain from settlements. Other such exemplary embodiments may involve liners with no perforations, multiple liners stacked atop one another, or liners without rigid surfaces. Some other exemplary embodiments may utilize a combination of aforementioned liner styles.

In some embodiments of the disclosure a wash basin 200 may be covered by one or more liners 202, fitted to keep it from being contaminated by the materials cleaned thereon. In some such embodiments the liner 204 may be fitted with different sized perforations 206 to drain fluid or smaller solid deposits and have one or more drawstrings 208 that allow the liner to be picked up, wrapped up and easily disposed of. In other such embodiments one or more liners 210 may be fitted with one or more perforations including smaller holes therein to form sheaves 210, causing only the finer liquids and solids to drain. In yet other such embodiments a liner 214 may comprise one or more magnets, which may be removable in some embodiments, fit into slots for magnets 216 or electromagnets in some embodiments, activated or charged by external devices 218 sending signals 220 so a liner to be easily attached to other liners or the surface of the basin.

In some other embodiments of the disclosure the basin covered may be a kitchen sink 300 while the multiple layers of liner 302 may be dispensed from a box 304, which in some embodiments may contain serrated edges allowing the liner to be sliced into multiple pieces so the user can fit it to the contours of the sink. In certain embodiments the liner may be moisture proof yet biodegradable by including a biodegradable moisture barrier layer sandwiched between the biodegradable resin layers. In other such exemplary embodiments layers may be recyclable.

In some embodiments of the disclosure a wash basin 400 may be covered by one or more liners 402, fitted to keep it from being contaminated by the materials cleaned thereon. In some such embodiments the liner 404 may be fitted with different sized perforations 406 to drain fluid or smaller solid deposits and be attached 408 to one or more perforation makers 414, 416 that allow the user to cut the liner in various shapes. In other such embodiments one or more liners 410 may be fitted with one or more perforations including smaller holes therein to form sheaves 412, causing only the finer liquids and solids to drain.

Some embodiments of the present disclosure may involve apparatus, methods, or systems for adapting the liners for multiple situations. For example, in some situations it may be preferable to have a liner with several suction cups to attach to the tub surface and one or more perforations. In some such embodiments the liner sheets may be made without perforations, but a cookie cutter attachment may be provided so that perforations can be cut in a variety of shapes as needed. In other embodiments a ridged liner may be preferable to retain cleaning powder. A grating or sand paper attachment may be provided to allow a user to turn a standard liner into a ridged liner that will retain the powder as necessary. In some exemplary embodiments the liner may be thin like a trash bag. In some other exemplary embodiments, the liner may be composed of recyclable materials. Another purpose of the liner is to prevent sediment, debris or other unwanted particulates from going down the drain and to make easy cleanup of the washbasin, tub or sink, protecting surfaces, pipelines and wastewater treatment plants.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the preferred embodiments described above, but rather to be limited only by the claims set out below. Thus, the invention encompasses all alternate embodiments that fall literally or equivalently within the scope of these claims.

Having thus described my invention, I claim:

1. A basin liner comprising:
a) one or more perforations
b) one or more attachments
or
c) a dispensing box.

2. The basin liner dispensing box described in claim 1 further comprising a serrated edge.

3. The basin liner described in claim 1 further comprising a perforation maker.

4. The basin liner described in claim 1 further comprising:
a) one or more magnets.

5. The basin liner described in claim 4 wherein one or more of said magnets is an electromagnet.

6. The basin liner described in claim 5 wherein one or more of said electromagnets is activated by an external device.

7. The basin liner described in claim 1 further comprising one or more biodegradable layers to the liner.

8. The basin liner described in claim 1 further comprising:
one or more indented sections to fit one or more magnets.

9. The basin liner described in claim 1 further comprising:
a plurality of ridges.

10. The basin liner described in claim 1 further comprising:
a) a removable surface layer,
b) a layer beneath the surface topped with one or more cleaning agents.

11. The basin liner described in claim 1 further comprising one or more surfaces that naturally bond to some metals, some ceramics, skin, or some plastics.

12. The basin liner described in claim 1 further comprising one or more surfaces that bond to some metals, some ceramics, skin, or some plastics when heated.

13. A system for attaching wash basin liners object comprising one or more removable electromagnets and one or more external devices, wherein one or more of said electromagnets is activated by one or more of the external devices.

14. The system of claim 13 further wherein the external device is a cell phone application.

15. The system of claim 13 further wherein the electromagnet is charged by the external device.

16. A method for building wash basin liners involving:
a) providing one or more liners to prevent sediment from going down the drain and making easy
b) providing a cutting attachment so that a user may fit the wash basin liners to a basin,
c) one or more removable attachments so that the wash basin liners may be attached to the basin or one another,
and
d) providing one or more perforation makers so that a user may create drain holes in the wash basin liner of varying sizes.

17. The method of claim 16 wherein one or more of said liners is biodegradable, comprising a biodegradable moisture barrier layer sandwiched between the biodegradable resin layers.

18. The method of claim 16 wherein one or more of said liners is comprised of recyclable materials.

19. The method of claim 16 further involving the steps of:
a) having one or more of the liners comprise suction cups as the attachment mechanism,
b) having one or more of the perforations extrude in a vertical direction so it is not flush with the liner,
and
c) providing one or more magnets to fit in the extruded ring perforation so a user may attach the liner to a basin drain.

20. The method of claim 16 further involving the steps of:
a) constructing the liner of material that will naturally bond to some metals, some ceramics, skin, or some plastics
or
b) Constructing the liner of material that will naturally bond to some metals, some ceramics or some plastics when heated.
